(19) United States
(12) Patent Application Publication
(10) Pub. No.: US 2007/0130832 A1
(43) Pub. Date: Jun. 14, 2007

(54) Methods and apparatus for converting a fuel source to hydrogen

(75) Inventors: Ke Liu, Rancho Santa Margrita, CA (US); Jennifer Lynn Molaison, Marietta, GA (US); Parag Prakash Kulkarni, Tustin, CA (US); Vladimir Zamansky, Oceanside, CA (US)

Correspondence Address: JOHN S. BEULICK (12764), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/301,806

(22) Filed: Dec. 13, 2005

(51) Int. Cl. C01B 3/32

(52) U.S. Cl. 48/198.7; 48/127.9

(57) ABSTRACT

An apparatus for producing hydrogen gas, wherein the apparatus includes a gasification unit or a reforming unit configured to form a first syngas and a first clean-up section is coupled to the gasification unit for acidic gas removal. The first clean-up section is configured to form a second syngas and includes at least one of a high temperature shift catalyst and a low temperature shift catalyst. The apparatus also includes a second clean-up section coupled to the first clean-up section for acidic gas removal.

### BACKGROUND OF THE INVENTION

This invention relates generally to gas separation processes, and more particularly, to methods and apparatus for separating carbon dioxide (CO₂) and hydrogen sulfide (H₂S) out of a syngas stream for converting a fuel source to hydrogen, or for syngas clean-up for an IGCC plant.

The commercialization of known ‘coal to-hydrogen (H₂) and electricity’ technologies such as integrated gasification combined cycle (IGCC) power plants and/or coal polygen plants) has generally been hampered by high capital costs associated with removing the most significant impurities, such as sulfur, from coal-derived syngas. Stringent purity requirements for hydrogen production, or fuel specifications for gas turbines, for example, are generally satisfied using a series of clean-up unit operations, which facilitate sulfur (S) removal, and CO₂ removal if CO₂ capture is required in the application. The use of a syngas purification process following a coal gasifier, as is typically used within IGCC power plants or with hydrogen production from coal or natural gas, facilitates the clean up process. Syngas purification is also used to facilitate purification of other hydrocarbon-derived syngas, including natural gases, heavy oils, biomasses and other sulfur-containing heavy carbon fuels. The resulting syngas produced can either be channeled to a combined cycle plant for use in producing electricity, or for H₂/ammonica (NH₃) production or channeled to Fischer-Tropsch synthesis/methanol reactors for use in polygeneration. The resulting CO₂ rich stream can be compressed further and sent to sequestration.

Because of the high temperatures in the coal gasifier (e.g. approximately 1400° C.), many pollutants contained within the coal may be released with the syngas. For example, within at least some known gasifiers, substantially all of the sulfur compounds within the coal are converted to hydrogen sulfide (H₂S) and some later changes to carbonyl sulfide (COS) while cooling down the syngas, and all of the chlorine compounds are converted to hydrogen chloride (HCl). As is known, generally more acidic gases, such as H₂S and HCl, are generally produced more from coal gasification than from natural gas partial oxidation. Thus, to optimize the gasifier performance in hydrogen production from coal, acid gas removal, especially sulfur removal, may be essential.

### BRIEF DESCRIPTION OF THE INVENTION

An apparatus for producing hydrogen gas is provided. The apparatus includes a gasification unit or a reforming unit configured to form a first syngas, and a first clean-up section is coupled to the gasification unit for acidic gas removal. The first clean-up section is configured to form a second syngas and includes at least one of a high temperature shift catalyst and a low temperature shift catalyst. The apparatus also includes a second clean-up section coupled to the first clean-up section for acidic gas removal.

A method for separating hydrogen from a fuel source is provided. The method includes forming a first gaseous fuel mixture via a gasification process and cooling the first gaseous fuel mixture with water injected from at least one water injection distributor. The method also includes channeling the first gaseous fuel mixture through a first clean-up section that includes a low-temperature hydrogen sulfide membrane coupled in flow communication with a high temperature shift catalyst and a low temperature shift catalyst. The method also includes forming a second gaseous fuel mixture that includes more hydrogen and less sulfur than the first gaseous fuel mixture and removing at least one of carbon dioxide and hydrogen sulfide from the second gaseous fuel mixture.

In further aspect, a hydrogen production system is provided. The system includes a gasification unit coupled to a carbonyl sulfide hydrolysis unit to produce a first gaseous fuel mixture, wherein the gasification unit is coupled in flow communication to a fuel source and at least one water injection distributor configured to inject water into the first gaseous fuel mixture to facilitate reducing the temperature of the first gaseous fuel mixture. The system also includes a first clean-up section coupled to the gasification unit and configured to produce a second gaseous fuel mixture, wherein the first clean-up section includes at least one of a high temperature shift catalyst and a low temperature shift catalyst. The system further includes a second clean-up section coupled to the first gaseous fuel mixture clean-up section, wherein the second clean-up section is configured to produce a third gaseous fuel mixture that includes more hydrogen than carbon dioxide and sulfur and a power generation unit configured to generate electricity using the third gaseous fuel mixture.

### BRIEF DESCRIPTION OF THE DRAWINGS

FIG. 1 is a schematic illustration of an exemplary hydrogen production system.

FIG. 2 is a schematic illustration of an alternative embodiment of a hydrogen production system.

FIG. 3 is a schematic illustration of a further alternative embodiment of a hydrogen production system.

FIG. 4 is a schematic illustration of another alternative embodiment of a hydrogen production system.

### DETAILED DESCRIPTION OF THE INVENTION

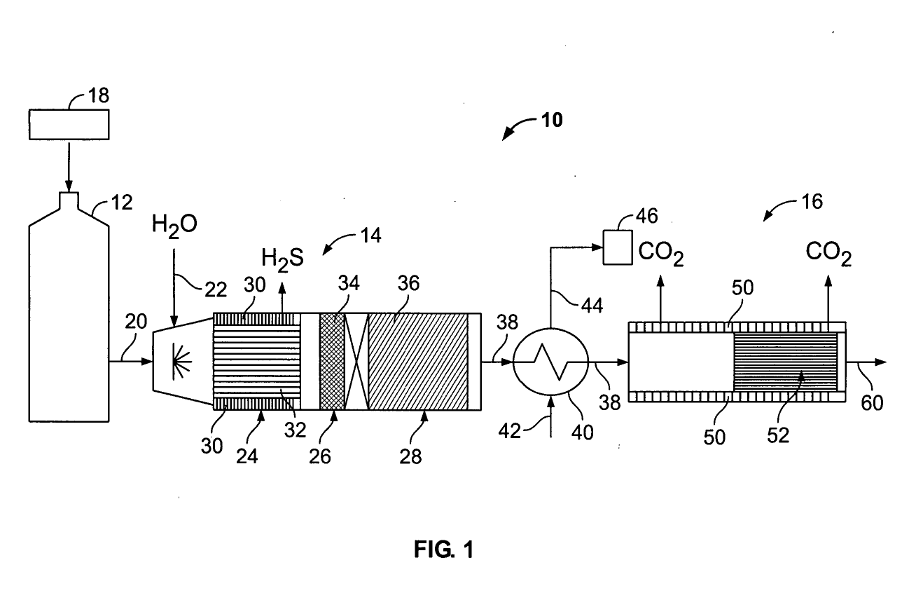

FIG. 1 is a schematic illustration of an exemplary hydrogen production system 10. In the exemplary embodiment, system 10 is configured to convert coal to hydrogen gas (H₂), and includes a gasification unit 12 coupled in series to a first clean-up section 14 and a second clean-up section 16. First and second cleanup sections 14 and 16, respectively are configured to facilitate carbon monoxide (CO) conversion, sulfur (S) removal, and carbon dioxide (CO₂) removal.

In the exemplary embodiment, gasification unit 12 is a coal gasifier 12 that is configured to convert fuel from a fuel source 18 into a syngas 20. In an alternative embodiment, gasification unit 12 is a natural gas reformer that is configured to convert natural gas into syngas 20. In the exemplary embodiment, fuel source 18 provides a coal slurry and oxygen or air. In alternative embodiments, fuel source 18 may provide any suitable combination of materials that enables gasification unit 12 to produce syngas 20 as described herein. In the exemplary embodiment, the syngas 20 produced includes a mixture of approximately 50% CO, approximately 30% H₂, less than approximately 10% CO₂ and hydrogen sulfide (H₂S). In alternative embodiments, the syngas 20 produced may include any suitable mixture of compounds at any percentage that allows the invention to function as described herein. In a further embodiment, gasification unit 12 includes radioactive and/or convective syngas coolers to cool down the syngas and use the energy to generate high temperature, high pressure steam to drive the steam turbine for power generation.

After being discharged from gasification unit 12, cooling fluid, such as water is injected into the syngas 20 via a water injection distributor 22 prior to the syngas 20 entering first clean-up section 14. In an alternative embodiment, cooling fluid is injected into syngas 20 via a plurality of injection ports 22. The cooling fluid facilitates reducing the temperature of the syngas 20 from approximately 1400° C. to less than approximately 170° C. In the exemplary embodiment, cooling syngas 20 facilitates preventing damage to components within section 14.

In the exemplary embodiment, first clean-up section 14 facilitates removing sulfur (S) compounds, such as, but not limited to H₂S. Section 14 includes a sulfur removal portion 24, a low temperature shift (LTS) reactor portion 26, and a high temperature shift (HTS) reactor portion 28. LTS reactor portion 26 operates at approximately 200-300° C. and HTS reactor portion 28 operates at approximately 300-400° C. In the exemplary embodiment, sulfur removal portion 24 is a H₂S selective membrane 30 that includes a carbonyl sulfide (COS) hydrolysis catalyst 32, and LTS reactor portion 26 includes a LTS catalyst 34. Moreover, in the exemplary embodiment, HTS reactor portion 28 includes an HTS catalyst 36.

H₂S selective membrane 30 facilitates removing substantial amounts of the H₂S from syngas 20. H₂S has a much higher reaction rate with the membrane material than CO₂, and thus can thus permeate through membrane 30 much quicker than CO₂, such that H₂S can be removed in an entrance section (not shown) of first clean-up section 14. Specifically, in the exemplary embodiment, a reduction from approximately 250 ppm to less than 10 ppb of H₂S is achievable in the entrance section of first clean-up section 14. Removing H₂S from the syngas 20 prior to the syngas 20 entering LTS reactor portion 26 facilitates preventing poisoning of catalyst 32 and thus rendering catalyst 32 ineffective. The H₂S and other acidic gases diffused from membrane 30 are purged via low-pressure steam supplied from a steam turbine (not shown). In one embodiment, membrane 30 includes catalyst 32 to ensure that H₂S removal will not exceed pre-established temperature limits of membrane 30. For example, in the exemplary embodiment, syngas 20 flows through membrane 30 at a temperature of approximately 170° C. In another embodiment, syngas 20 flows through membrane 30 at a temperature less than 200° C.

After being discharged from the sulfur removal portion 24 of section 14, the syngas 20 is channeled through LTS reactor 26 wherein the temperature elevates to approximately 250° C. such that an exothermic reaction lights-off or occurs. Specifically, in the exemplary embodiment, LTS catalyst 34 converts a portion of the CO present in syngas 20 to CO₂. In the exemplary embodiment, LTS catalyst 34 is optimized for low temperature operation. In one embodiment, LTS catalyst 34 operates at about 250° C. In one embodiment, LTS catalyst 34 facilitates a thermodynamically limited water-gas-shift (WGS) reaction (CO+H₂O [symbol] CO₂+H₂) and converts CO to CO₂, but does not proceed to completion in the presence of CO₂.

In one embodiment, LTS catalyst 34 includes Copper (Cu) Zinc (Zn) alloys. In another embodiment, LTS catalyst 34 could be a noble metal catalyst such as, but not limited to, Palladium (Pd), Platinum (Pt), Rhodium (Rh), or Platinum rhenium (Pt—Re) supported on high surface area support such as, but not limited to, Cerium oxide (CeO₂) or Aluminum Oxide (Al₂O₃). Syngas 20 exits LTS reactor 26 at a temperature of approximately 250° C. and as a mixture of CO, H₂, and CO₂.

After being discharged from LTS reactor 26, the syngas 20 is channeled through HTS reactor 26 wherein the temperature elevates to approximately 450° C. HTS reactor 26 is packed with HTS catalyst 36 that continues the thermodynamically-limited water-gas-shift reaction (CO+H₂O [symbol] CO₂+H₂) and continues to converts CO to CO₂, but does not proceed to completion in the presence of CO₂, thus leaving approximately 3% CO in the syngas 20. In the exemplary embodiment, HTS catalyst 36 is optimized for high temperature operation. In one embodiment, HTS catalyst 36 includes Cu and Zn alloys. In another embodiment, HTS catalyst 36 could be a noble metal catalyst such as, but not limited to, Pd, Pt, Rh, or Pt—Re supported on high surface area support such as, but not limited to, CeO₂ or Al₂O₃. As the syngas 20 flows through HTS reactor 28 and HTS catalyst 34, the temperature elevates to approximately 450° C. and the syngas 20 is converted into a syngas 38.

After being discharged from section 14, the syngas 38 produced includes a mixture of approximately 3% CO, approximately 55% H₂, approximately 40% CO₂ and substantially stripped of H₂S. In alternative embodiments, the syngas 38 produced may include any suitable mixture of compounds at any percentage that allows the invention to function as described herein.

Syngas 38 is then channeled to a heat exchanger 40 where the temperature of the syngas 38 is reduced. Specifically, in the exemplary embodiment, a catalyst 42 is circulated through heat exchanger 40 such that the temperature of the syngas 38 is reduced to approximately 170° C. As the syngas 38 cools, steam 44 is expelled from heat exchanger 40 and directed to a steam turbine 46. Heat exchanger 40 lowers the temperature of the syngas 38 such that it enters second clean-up section 16 at a temperature that will facilitate preventing damage to critical components within section 16.

In the exemplary embodiment, section 16 is a WGS reactor 16 including a CO₂ selective membrane 50 wherein at least a portion of membrane 50 includes a LTS catalyst 52. LTS catalyst 52 is optimized for low temperature operation. In one embodiment, LTS catalyst 52 is the same as LTS catalyst 32. In alternative embodiments, LTS catalyst 52 is different from LTS catalyst 32. In one embodiment, LTS catalyst 52 includes Cu and Zn alloys. In another embodiment, LTS catalyst 52 could be a noble metal catalyst such as, but not limited to, Pd, Pt, Rh, or Pt—Re supported on high surface area support such as, but not limited to, CeO₂ or Al₂O₃.

Membrane 50 is configured to reduce the amount of CO₂ to less than approximately 0.1%. As the syngas 38 flows through CO₂ selective membrane 50 and LTS catalyst 52, the temperature elevates due to the substantially continuous removal of CO₂ to sequestration. The conversion of the WGS reaction in section 16 can produce very high temperatures, therefore LTS catalyst 52 is packed in membrane 50 such that the exothermic WGS reaction will not exceed the temperature limits of membrane 50. In the exemplary embodiment, LTS catalyst 52 facilitates maintaining the temperature within membrane 50 at approximately 200° C.

In the exemplary embodiment, system 10 produces a resultant stream 60 of H₂ containing approximately 95% H₂ and less than approximately 0.1% CO₂. In one embodiment, stream 60 is channeled to a gas turbine IGCC (not shown). In alternative embodiments, stream 60 is directed to a hydrogen storage facility (not shown).

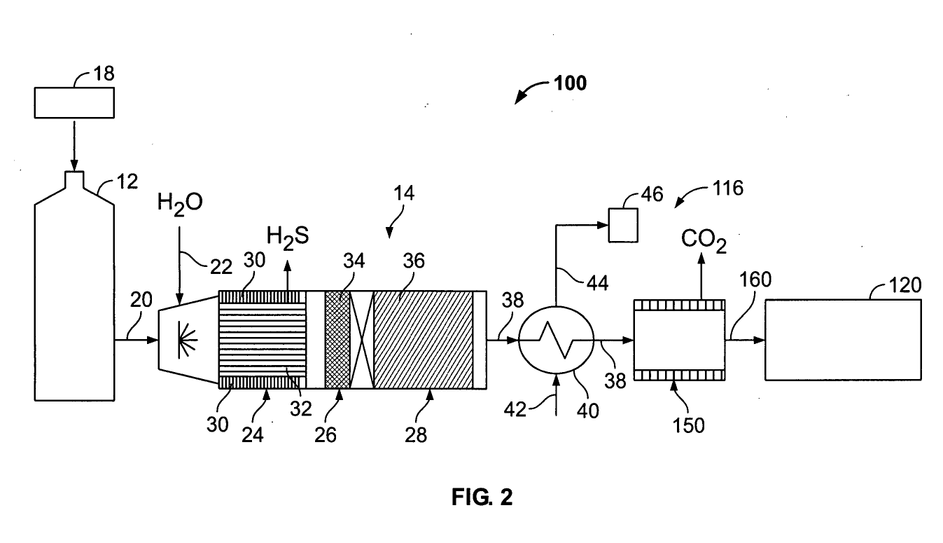

FIG. 2 is a schematic illustration of an alternative embodiment of a hydrogen production system 100. Hydrogen production system 100 is similar to hydrogen production system 10, (shown in FIG. 1) and components of hydrogen production system 100 that are identical to syngas purification system 10 are identified in FIG. 2 using the same reference numbers used in FIG. 1.

In the exemplary embodiment, system 100 is configured to convert coal to H₂, and includes gasification unit 12 coupled in series to first clean-up section 14 and a second clean-up section 116. Second clean-up section 116 is configured to facilitate CO conversion and CO₂ removal. In the exemplary embodiment, gasification unit 12, first clean-up section 14, fuel source 18, syngas 20, and heat exchanger 40 are configured and function as described in FIG. 1. As the syngas 20 flows through section 14, the temperature elevated to approximately 450° C. and the syngas 20 is converted to syngas 38.

After being discharged from heat exchanger 40, the syngas 38 is channeled to second clean-up section 116 at a temperature of approximately 170° C. In one embodiment, section 116 is a CO₂ selective membrane 150 configured to remove CO₂ to sequestration. The temperature of the syngas 38 remains 170° C. within section 116. In the exemplary embodiment, system 100 produces a resultant stream 160 of H₂ containing approximately 90% H₂ and approximately 5% CO₂. In one embodiment, stream 160 is directed to a gas turbine 120.

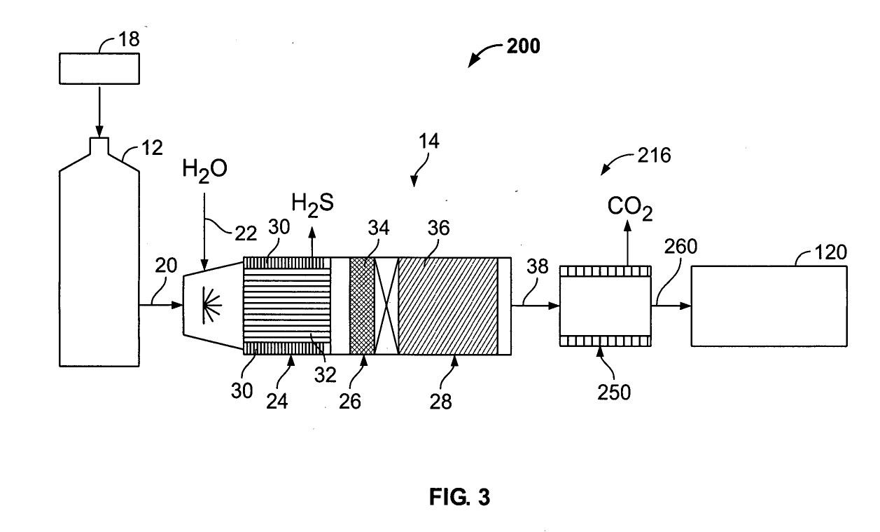

FIG. 3 is a schematic illustration of a further embodiment of a hydrogen production system 200. Hydrogen production system 200 is similar to hydrogen production system 100, (shown in FIG. 2) and components of hydrogen production system 200 that are identical to syngas purification system 100 are identified in FIG. 3 using the same reference numbers used in FIG. 2.

In the exemplary embodiment, system 200 is configured to convert coal to H₂, and includes gasification unit 12 coupled in series to first clean-up section 14 and a second clean-up section 216. Second clean-up section 216 is configured to facilitate CO conversion and CO₂ removal. In the exemplary embodiment, gasification unit 12, first clean-up section 14, fuel source 18, and syngas 20 are configured and function as described in FIG. 1. As the syngas 20 flows through section 14, the temperature elevated to approximately 450° C. and the syngas 20 is converted to syngas 38.

After being discharged from first clean-up section 14, the syngas 38 is channeled to second clean-up section 216 at a temperature of approximately 450° C. In one embodiment, section 116 is a high temperature CO₂ selective membrane 250 is configured to substantially remove the CO₂ in syngas 38 and direct it to sequestration. In the exemplary embodiment, the temperature limit of membrane 250 is approximately 450° C. In the exemplary embodiment, system 200 produces a resultant stream 260 of H₂ containing approximately 90% H₂ and approximately 5% CO₂. In one embodiment, stream 260 is directed to an IGCC or gas turbine 120.

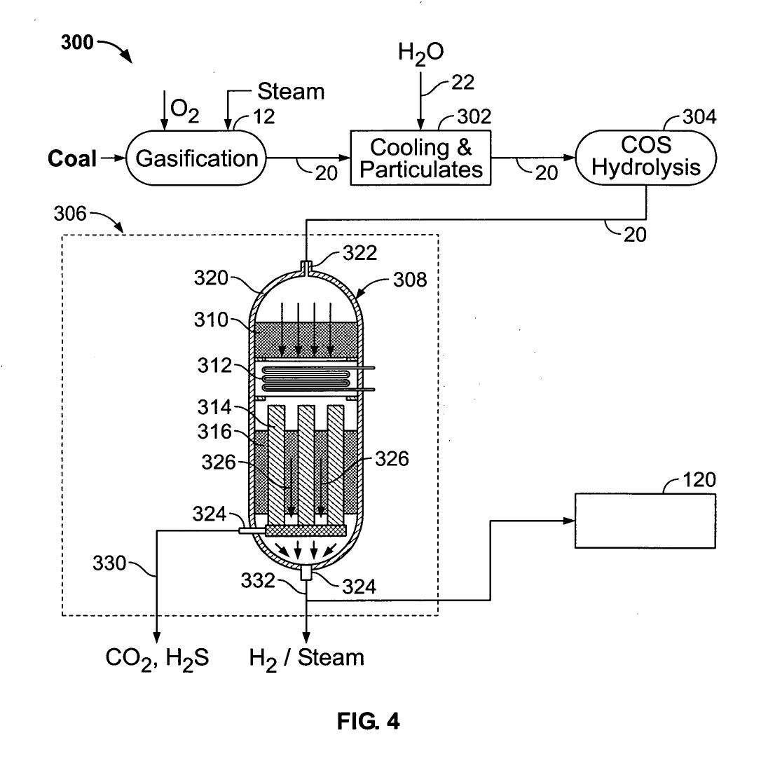

FIG. 4 is a schematic illustration of another embodiment of an exemplary hydrogen production system 300. Hydrogen production system 300 is similar to hydrogen production system 10, (shown in FIG. 1) and components of IGCC plant 300 that are identical to hydrogen production system 10 are identified in FIG. 4 using the same reference numbers used in FIG. 1.

In the exemplary embodiment, system 300 is configured to convert coal to H₂, and includes gasification unit 12 in flow communication with a series of syngas coolers 302 configured to remove heat and particulates and with a COS hydrolysis unit 304 that is configured to convert COS to H₂S in the syngas 20. The syngas 20 is then processed through an integrated, syngas clean-up section 306 configured to facilitate CO conversion, S removal, and CO₂ removal.

In the exemplary embodiment, clean-up section 306 includes a WGS reactor 308 including a HTS catalyst 310, an active cooling heat exchanger 312, a membrane 314, and a LTS catalyst 316. In the exemplary embodiment, reactor 308 includes a shell 320 that includes at least one input channel 322 and a plurality of output channels 324. Reactor 308 is configured to receive the syngas 20 through input channel 322 at a temperature between approximately 250° C. and 300° C.

As the syngas 20 is directed through HTS catalyst 310 within shell 320, an exothermic WGS reaction (CO+H₂O [symbol] CO₂+H₂) converts CO to CO₂. In the exemplary embodiment, HTS catalyst 310 is packed within shell 320 such that the syngas 20 flows through HTS catalyst 310 prior to entering heat exchanger 312. HTS catalyst 310 maintains the syngas 20 at a temperature between approximately 170° C. and 200° C. In one embodiment, HTS catalyst 310 includes Cu Fe and Zn alloys. In another embodiment, HTS catalyst 310 could be a noble metal catalyst such as, but not limited to, Pd, Pt, Rh, or Pt—Re supported on high surface area support such as, but not limited to, CeO₂ or Al₂O₃. In the exemplary embodiment, HTS catalyst 310 is sulfur tolerant and is not poisoned by the presence of sulfur in the syngas 20.

Heat exchanger 312 facilitates removing excess heat from the exothermic shift reactions by actively cooling the syngas 20 prior to entering membrane 314. Specifically, heat exchanger 312 reduces the syngas 38 temperature to between approximately 170° C. and 200° C. Lowering the temperature of syngas 38 facilitates protecting membrane 314 from damage.

In the exemplary embodiment, membrane 314 is CO₂ selective and thus continuously removes the CO₂ produced in the WGS reactor 308, allowing the equilibrium conversion of CO to CO₂ to proceed to nearly complete CO removal (approximately 10 ppm CO in H₂ product). In the exemplary embodiment, membrane 314 is integrated with LTS catalyst 316 such that substantially all of the CO₂ produced in the WGS reaction is removed. Membrane 314 is also H₂S selective and thus continuously removes H₂S to facilitate achieving low levels of H₂S (<100 ppb) in the H₂ product. Moreover, in the exemplary embodiment, membrane 314 is operable at a decreased temperature i.e., between approximately 170-200° C. The decreased operating temperature facilitates reducing energy losses associated with cooling and reheating.

In one embodiment, membrane 314 can be a high flux polymer membrane or a high temperature inorganic membrane. The decision of which kind of membrane to be chosen will depend on the permeability, the selectivity, and the temperature operation range desired for membrane 314. To extend the temperature range of a high flux polymer membrane, one can mix certain portions of a porous particle such as, but not limited to, zeolite particles into the polymer solution before making the membrane. One can also fill the macro-porous ceramic foam with a polymer to extend the temperature durability of such a high flux membrane.

During operations, in the exemplary embodiment, CO₂ and H₂S pass through membrane 314 to a plurality of center membrane tubes 326. A first separate stream 330, which is enriched in CO₂ and H₂S, is removed from reactor 308 via output channel 324. The bulk of processed syngas 20 exits in a second stream 332 of steam and H₂, which is depleted in CO₂ and H₂S. In one embodiment, stream 332 is directed to gas turbine 120 or an IGCC. In one embodiment, a low quality steam or a sweep gas (not shown) is introduced in to reactor 308 to facilitate removing the CO₂ and H₂S.

In another embodiment, membrane 314 can be constructed from two separate materials, wherein the first material is selective for CO₂ and the second is selective for H₂S. In this embodiment, the CO₂ selective membrane is substantially encapsulated within HTS catalyst 310 and H₂S selective membrane can be located downstream in LTS catalyst 316. The result is three separate streams exiting reactor 308, the first stream for H₂, the second for CO₂, and the third for H₂S. The third stream can be further converted to elemental sulfur or sulfuric acid.

The above-described system based on low-temperature membrane separation of CO₂ and H₂S from syngas offers many advantages for an integrated coal-to-H₂ process. The integrated concept allows for reduced energy cost in CO₂ separation and capture, lower capital cost, and a smaller overall footprint for the system. Furthermore, the integrated approach leverages synergies between water-gas shift reactions and the need for CO₂ and H₂S removal. The use of membranes for H₂S removal eliminates the need for energy-intensive solvent regeneration and sulfur recovery units. The economic benefits of the module will facilitate commercialization of IGCC or coal to H₂ or polygeneration plants with CO₂ separation. Reduced capital costs will have a significant impact on the economic feasibility of coal-based H₂ production technologies.

Exemplary embodiments of low temperature syngas clean-up sections are described in detail above. The syngas clean-up section is not limited to the specific embodiments described herein, but rather, components of the clean-up sections may be utilized independently and separately from other components described herein. Furthermore, the need to remove CO₂ and H₂S is not unique to coal-derived plants, and as such, the integrated syngas clean-up section could be used for alternative fuel/biomass systems to convert low-value syngas to high-purity H₂. Therefore, the present invention can be implemented and utilized in connection with many other fuel systems and turbine configurations.

While the invention has been described in terms of various specific embodiments, those skilled in the art will recognize that the invention can be practiced with modification within the spirit and scope of the claims.

What is claimed is:

1. An apparatus for producing hydrogen gas, said apparatus comprising:
a gasification unit or a reforming unit configured to form a first syngas;
a first clean-up section coupled to said gasification unit for acidic gas removal, said first clean-up section configured to form a second syngas, said first clean-up section comprises at least one of a high temperature shift catalyst and a low temperature shift catalyst; and
a second clean-up section coupled to said first clean-up section for acidic gas removal.

2. An apparatus in accordance with claim 1 further comprising a heat exchanger coupled in flow communication with said first clean-up section and said second clean-up section.

3. An apparatus in accordance with claim 2 wherein said heat exchanger is configured to remove excess heat via active cooling of the first syngas.

4. An apparatus in accordance with claim 1 further comprising at least one water injection distributor in coupled in flow communication with said first clean-up section and configured to actively cool the first syngas.

5. An apparatus in accordance with claim 1 further comprising a low-temperature hydrogen sulfide membrane configured to selectively remove hydrogen sulfide from the first syngas such that said first clean-up section produces the second syngas, wherein the second syngas produced is substantially sulfur depleted.

6. An apparatus in accordance with claim 1 further comprising a low-temperature carbon dioxide membrane configured to selectively remove carbon dioxide from the first syngas said high temperature shift catalyst and said low temperature shift catalyst to facilitate said second clean-up section producing a third syngas that is substantially carbon dioxide depleted.

7. An apparatus in accordance with claim 1 further comprising a low-temperature carbon dioxide membrane configured to selectively remove carbon dioxide from the second syngas to facilitate said second clean-up section producing a third syngas that is substantially carbon dioxide depleted.

8. An apparatus in accordance with claim 1 wherein at least one of said high temperature shift catalyst and low temperature shift catalyst is configured to convert carbon monoxide and steam to carbon dioxide and hydrogen.

9. An apparatus in accordance with claim 1 further comprising a reactor coupled to said gasification unit, said reactor comprises a shell comprising a plurality of input channels and a plurality of output channels, said shell configured to substantially contain an exothermic water-gas-shift reaction therein, and maintain a temperature of between approximately 170° C. and 300° C.

10. An apparatus in accordance with claim 9 wherein said reactor shell is sized to house said high temperature shift catalyst, said low temperature shift catalyst, a heat exchanger, and at least one of a low-temperature carbon dioxide and a hydrogen sulfide selective membrane integrated with said low temperature shift catalyst therein.

11. A method for separating hydrogen from a fuel source, said method comprises:
forming a first gaseous fuel mixture via a gasification process;
cooling the first gaseous fuel mixture with water injected from at least one water injection distributor;
channeling the first gaseous fuel mixture through a first clean-up section that includes a low-temperature hydrogen sulfide membrane coupled in flow communication with a high temperature shift catalyst and a low temperature shift catalyst;
forming a second gaseous fuel mixture that includes more hydrogen and less sulfur than the first gaseous fuel mixture; and
removing at least one of carbon dioxide and hydrogen sulfide from the second gaseous fuel mixture.

12. A method in accordance with claim 11 wherein said removing at least one of carbon dioxide and hydrogen sulfide from the second gaseous fuel mixture further comprises using a second clean-up section that is configured to form a third gaseous fuel mixture that includes more hydrogen than the second gaseous fuel mixture.

13. A method in accordance with claim 11 further comprising coupling a heat exchanger in flow communication between the first clean-up section and a second cleanup section, wherein the heat exchanger is configured to actively cool a gaseous fuel mixture discharged from the second clean-up section.

14. A method in accordance with claim 11 wherein said channeling the first gaseous fuel mixture through a first clean-up section further comprises channeling the first gaseous fuel mixture through a low-temperature carbon dioxide and hydrogen sulfide membrane to facilitate selectively removing at least one of carbon dioxide and hydrogen sulfide from the first gaseous fuel mixture.

15. A method in accordance with claim 11 wherein removing at least one of carbon dioxide and hydrogen sulfide from the second gaseous fuel mixture further comprises removing carbon dioxide and hydrogen sulfide into a first stream.

16. A method in accordance with claim 11 wherein removing at least one of carbon dioxide and hydrogen sulfide from the second gaseous fuel mixture further comprises removing a first stream of carbon dioxide and a separate second stream of hydrogen sulfide from the second gaseous fuel mixture.

17. A hydrogen production system comprising:
a gasification unit coupled to a carbonyl sulfide hydrolysis unit to produce a first gaseous fuel mixture, said gasification unit coupled in flow communication to a fuel source;
at least one water injection distributor configured to inject water into said first gaseous fuel mixture to facilitate reducing a temperature of the first gaseous fuel;
a first clean-up section coupled to said gasification unit and configured to produce a second gaseous fuel mixture, said first clean-up section comprises at least one of a high temperature shift catalyst and a low temperature shift catalyst;
a second clean-up section coupled to said first clean-up section, said second clean-up section configured to produce a third gaseous fuel mixture that includes more hydrogen than carbon dioxide and/or sulfur; and
a power generation unit configured to generate electricity using the third gaseous fuel mixture.

18. A hydrogen production system in accordance with claim 17 wherein said fuel source is selected from at least one of a coal, a natural gas, an oil, and a biomass, and said power generation unit comprises at least one of an integrated gasification combined cycle plant and a coal polygeneration plant.

19. A hydrogen production system in accordance with claim 17 further comprising a heat exchanger coupled in flow communication with said first clean-up section and said second clean-up section.

20. A hydrogen production system in accordance with claim 17 further comprising at least one of a low-temperature carbon dioxide and low-temperature hydrogen sulfide membrane coupled to at least one of said first clean-up section and said second clean-up section, said at least one of a low-temperature carbon dioxide and low-temperature hydrogen sulfide membrane configured to facilitate removing at least one of carbon dioxide and hydrogen sulfide from at least one of said first gaseous fuel mixture and said second gaseous fuel mixture.
